(19) United States
(12) Patent Application Publication
(10) Pub. No.: US 2010/0078143 A1
(43) Pub. Date: Apr. 1, 2010

(54) METHOD FOR MANUFACTURING A DUPLICATING STAMPER

(75) Inventors: Takuya SHIMADA, Kanagawa-ken (JP); Shinobu Sugimura, Kanagawa-ken (JP); Yoshiyuki Kamata, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/556,278

(22) Filed: Sep. 9, 2009

(30) Foreign Application Priority Data
Sep. 29, 2008 (JP) 2008-250840

(51) Int. Cl. B41C 3/02

(52) U.S. Cl. 164/2

(57) ABSTRACT

A method for manufacturing a duplicating stamper is provided. The method includes the steps of forming a metal film on a stamper, the metal film having an apertural area in a central area of the stamper, lifting up an innermost circular edge of the metal film in order to detach the metal film from the innermost circular edge to the outermost circular edge, and detaching the metal film to provide another stamper. Alternatively, for detaching the metal film, a gas is blown into the apertural area with lifting up the innermost circular edge of the metal film.

### CROSS REFERENCE TO RELATED APPLICATION

This application is based upon and claims the benefit of priority from the Japanese Patent Application No. 2008-250840, filed on Sep. 29, 2008, the entire contents of which are incorporated herein by reference.

### FIELD OF THE INVENTION

The present invention relates to a method for manufacturing a duplicating stamper which is a metallic mold used for imprint techniques to manufacture information recording media, etc.

### DESCRIPTION OF THE BACKGROUND

There is known a discrete type (Discrete Track Recording: DTR) medium with two or more tracks for data recording (referred to simply as “track”s below) formed concentrically or spirally thereon as a high-density magnetic recording medium. A stamper is used for manufacturing the DTR media as a metallic mold. The stamper is produced, e.g., in the following process.

First, an original disk is formed on the surface of a glass or Si substrate, the disk having a concavo-convex track pattern, the pattern being formed concentrically or spirally thereon. Second, a conducting film is formed very thinly on the surface of the original disk. Third, a first electroformed film is further formed thick on the conducting film by electroforming.

Finally, the laminated film including the electroformed film and the conducting film is detached from the original disk to provide a father stamper. The detaching of the father stamper is initiated firstly from an end of the outermost circular edge of the laminated film to develop from the end toward the other end opposite to the end.

Then, after forming an oxide film as a mold release film on the surface of the father stamper to ease detaching, a second electroformed film is formed thick on the oxide film. Then, the second electroformed film is detached from the father stamper to provide a mother stamper. The detaching for the mother stamper is carried out in a similar way to that for the father stamper. That is, an end of the outermost circular edge of the second electroformed film is detached initially, and the detaching of the second electroformed film further develops from the end edge toward an opposite end of the outermost circular edge to provide a mother stamper.

Furthermore, a son stamper is duplicated in a similar way to the mother stamper. The son stamper duplicated like this is fixed to the metallic mold of a plastic injection molding machine to mass-produce media with the same track pattern as that of the original disk on the basis of transfer printing of the pattern (JP-A 2005-50513 (Kokai)).

According to conventional methods for manufacturing stampers, detaching a father stamper from an original disk and further detaching a son stamper from a mother stamper are carried out from an end of the outermost circular edge of the stamper toward the other end opposite to the end. Such methods can give rise to deformations of the shape of the stamper itself, creating a risk that the track of a hard disk which should be a perfect circle is distorted in shape and becomes ellipsoidal.

The use of the DTR media manufactured using such methods leads to a case that a magnetic head cannot trace a deformed track, thus misaligning the magnetic head and the track to cause RRO (Repeatable Run Out, synchronous distortion).

Furthermore, since the detaching is carried out from an end of the outermost circular edge of the stamper toward the other end opposite to the end thereof, dusts are easy to mix in, for example, between the father stamper and the original disk at the time of the detaching. The dusts are inherited by the media-manufacturing process. The dusts adhered onto the DTR media prevent the magnetic head from flying. That is, the dusts collide with the flying head in some cases, the read/write action of the head becoming impossible.

### SUMMARY OF THE INVENTION

According to a first aspect of the invention, a method for manufacturing a duplicating stamper includes the following steps:
forming a metal film on a stamper, the metal film having an apertural area in a central area of the stamper;
lifting up an innermost circular edge of the metal film in order to detach the metal film from the innermost circular edge to the outermost circular edge; and
detaching the metal film to provide another stamper.
   Alternatively, a gas is blown into the apertural area with lifting up the innermost circular edge of the metal film.

According to a second aspect of the invention, a method for manufacturing a duplicating stamper includes the following steps:
placing a first pin on a surface of a central area of an original disk, the first pin having a column and a bottom of which diameter is larger than that of the column, so that the bottom of the first pin is in contact with the surface of the central area of the original disk;
forming a first metal film on the surface of the original disk and on the bottom of the first pin;
detaching the first metal film from the original disk to provide a father stamper with a first apertural area in a central portion of the father stamper;
placing a second pin with a column and a bottom of which diameter is larger than that of the column so as to screen the first apertural area of the father stamper to form a second metal film on a surface of the father stamper and on the bottom of the second pin;
detaching the second metal film from the father stamper to provide a mother stamper with a second apertural area in a central portion of the mother stamper;
placing a third pin with a column and a bottom of which diameter is larger than that of the column so as to screen the second apertural area of the mother stamper to form a third metal film on a surface of the mother stamper and on the bottom of the third pin; and
detaching the third metal film from the mother stamper to provide a son stamper.
   In addition, the first pin, the second pin and the third pin have an air duct provided along a central axis of the columns of the first pin, the second pin and the third pin. Furthermore, a gas is instilled into the apertural areas through the air ducts of the first pin, the second pin and the third pin with lifting up the innermost circular edges of the first metal film, the second metal film and the third metal film to make it easier to detach the first metal film, the second metal film and the third metal film.

### BRIEF DESCRIPTION OF DRAWINGS

The accompanying drawings, which are incorporated in and constitute a part of this specification, illustrate embodiments of the invention and together with the description, serve to explain the principles of the invention.

FIGS. 1A to 1C are schematic sectional-views of stampers at respective manufacturing steps according to the first embodiment, showing a process to form an electroformed film on an original disk.

FIGS. 2A to 2C are schematic sectional-views of stampers at respective manufacturing steps according to the first embodiment, showing a process to detach a laminated film of a first electroformed film and a first conducting film from the original disk.

FIGS. 3A to 3C are schematic sectional-views of stampers at respective manufacturing steps according to the first embodiment, showing a process to form a mold release film on a father stamper and to subsequently form a first electroformed film thereon.

FIGS. 4A to 4C are schematic sectional-views of stampers at respective manufacturing steps according to the first embodiment, showing the steps of detaching the electroformed film from the father stamper, forming a second electroformed film on a mother stamper and detaching the second electroformed film to form the mother stamper for providing a son stamper.

FIGS. 5A to 5D are schematic sectional-views of stampers at respective manufacturing steps according to the second embodiment, showing a process to form a first conducting film for electroforming on an original disk with a first pin placed thereon.

FIGS. 6A to 6D are schematic sectional-views of stampers at respective manufacturing steps according to the second embodiment, showing a process to form a first electroformed film on the original disk with the first pin placed thereon and to subsequently detach the first electroformed film by lifting the innermost circular edge initially.

FIGS. 7A to 7D are schematic sectional-views of stampers at respective manufacturing steps according to the second embodiment, showing a process to unfix the first pin from a father stamper and to subsequently place a second pin on a concavo-convex pattern of the father stamper.

FIGS. 8A to 8D are schematic sectional-views of stampers at respective manufacturing steps according to the second embodiment, showing a process to form the mold release film 72 on the father stamper with the second pin placed thereon and to subsequently form a second electroformed film thereon, of which innermost circular edge is lifted for detaching.

FIGS. 9A to 9C are schematic sectional-views of stampers at respective manufacturing steps according to the second embodiment, showing a process to unfix the second pin from the second electroformed film to provide a mother stamper.

FIGS. 10A to 10D are schematic sectional-views of stampers at respective manufacturing steps according to the second embodiment, showing a process to form a second mold release film 92 on the mother stamper 802 with the pin 432 thereon.

FIGS. 11A to 11C are schematic sectional-views of stampers at respective manufacturing steps according to the second embodiment, showing a process to form a third electroformed film 102 and to subsequently detach the third electroformed film.

FIGS. 12A to 12C are schematic sectional-views of stampers at respective manufacturing steps according to the second embodiment, showing a process to unfix a third pin and to clean the third electroformed film for a son stamper.

FIG. 13 is a schematic view showing a pin to be used in the manufacturing process according to the second embodiment.

### DETAILED DESCRIPTION OF THE EMBODIMENTS

Embodiments of the present invention are described below with reference to the accompanying drawings. The same reference numerals denote the same portions. All the figures are schematic views for illustrating the invention. The shapes, dimension ratios, etc. may differ from actual models. The shapes or dimension ratios may be subjected to design changes with reference to the descriptions below and publicly known techniques.

### First Embodiment

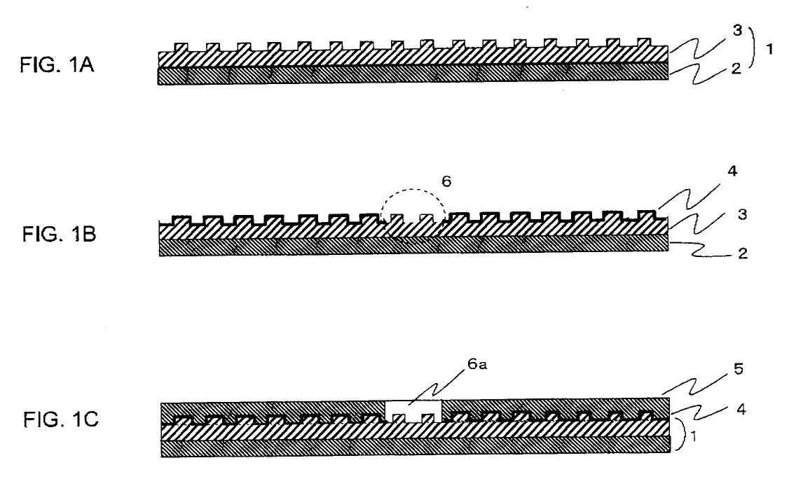

A method for manufacturing a duplicating stamper is explained with reference to FIGS. 1A to 4C. FIGS. 1A to 4C are sectional views of the stamper at respective manufacturing steps according to the first embodiment.

FIGS. 1A to 1C show a process to form an electroformed film on an original disk 1. As shown in FIG. 1A, a glass substrate 2 is coated with a resist to form a resist film 3 thereon by spin-coating. The resist film 3 is irradiated with an electron beam (EB) to form a latent image of a track pattern for a DTR medium. The resist film 3 with the latent image is developed to provide an original disk 1 having a concavo-convex and concentric track-pattern thereon.

Then, a first conducting film 4 is formed on the concavo-convex surface of the resist film 3 of the original disk 1 as shown in FIG. 1B. The first conducting film 4 is a seed film to form a first electroformed film 5 (a first metal film) entirely on the original disk 1 except for a central portion thereof, as shown in FIG. 1C. The first conducting film 4 is formed with a thickness of about 20 nm by sputtering, the first conducting film including metallic materials such as Ni, etc.

After forming the first conducting film 4, the original disk 1 with the first conducting film 4 thereon is immersed in an electrolysis solution to deposit a first electroformed film 5 with a thickness of 300 μm on the surface of the first conducting film 4 by electroforming. The first electroformed film 5 includes Ni, and is electroformed by immersing the original disk 1 with the first conducting film 4 in a bath of nickel-sulfamate as electrolysis solution. The state of the original disk 1 after the electroforming is shown in FIG. 1C.

The first electroformed film 6 is deposited on the remainder area except for the central portion 6, because the first conducting film 4 as the seed film is not deposited on the central portion 6 of the original disk 1 as shown in FIG. 1B. This provides a laminated film with a first apertural area 6a, the laminated film including the first conducting film 4 and the first electroformed film 5. The first apertural area 6a is provided in order to detach the first electroformed film 5 from the original disk 1 at a later step of this manufacturing method. The first apertural area 6a is made to be circular in order to concentrically detach the laminated film including the first electroformed film 5 and the first conducting film 4. When the first conducting film 4 is deposited on the resist film 3 of the original disk 1, screening the circular central area 6 of the original disk 1 provides the first apertural area 6a.

Then, the first electroformed film 5/the first conducting film 4 is detached to provide a father stamper 50 having an inverted pattern in comparison with the original disk 1. The detaching is carried out as follows.

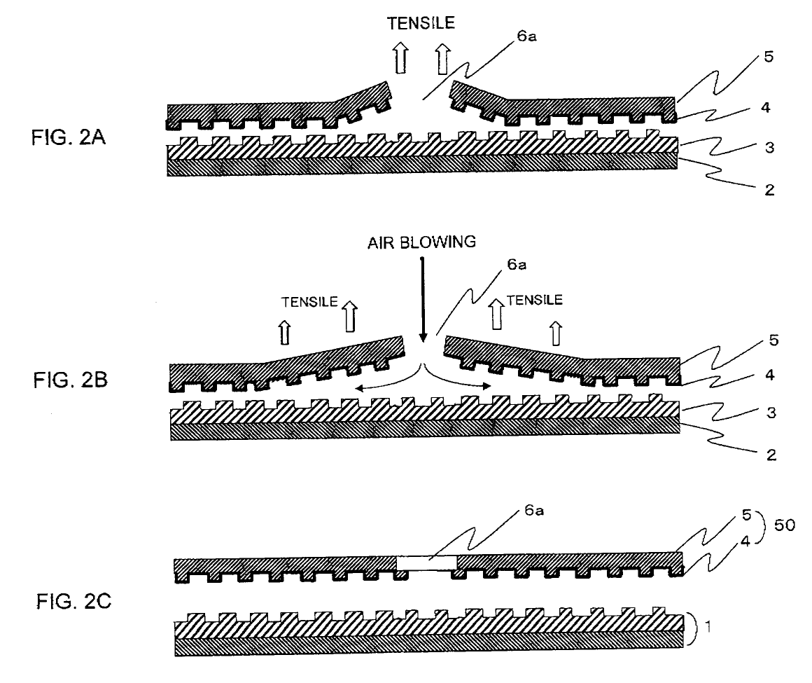

FIGS. 2A to 2C show a process to detach the laminated film of the first electroformed film 5 and the first conducting film 4 from the original disk 1. The innermost circular edge of the laminated film in the first apertural area 6a is pulled toward the upper direction to initiate the detaching from the innermost edge concentrically as shown in FIG. 2A. The detaching develops concentrically from the innermost circular edge to the outermost circular edge of the laminated film of the first electroformed film 5 and the first conducting film 4. Thus, the laminated film is detached from the resist film 3. Adhesion between the laminated film and the resist film 3 is basically low, because the laminated film and the resist film 3 are metallic and organic, respectively, allowing it to easily detach the laminated film from the resist film 3

As shown in FIG. 2A, the innermost circular edge in the first apertural area 6a, which has been detached initially, is pulled and lifted uniformly over the whole circumference thereof toward the upper direction shown as white arrows in the figure. The laminated film of the first electroformed film 5/the first conducting film 4, of which innermost circular edge in the first apertural area 6a has been lifted, is subjected to a progress of the detaching thereof toward the outermost circular edge. Finally, the laminated film is detached completely to accomplish the step of detaching, as shown in FIG. 2C.

Alternatively, the detaching may be carried out with blowing air into the first apertural area 6a, as shown in FIG. 2B. The air acts so as to lift the laminated film including the first electroformed film 5 and the first conducting film 4 in the first apertural area 6a. This action of the air assists the detaching to allow it to detach the laminated film more easily.

In FIGS. 1A to 2C, the innermost circular edge of the laminated film around at the first apertural area 6a is drawn as if deformed greatly during the detaching. In fact, the deformation of the laminated film takes place within a range of the elastic deformations thereof. Therefore, no plastic deformation accompanied by the detaching remains at the innermost circular edge of the first electroformed film 5/the first conducting film 4 constituting the father stamper 50.

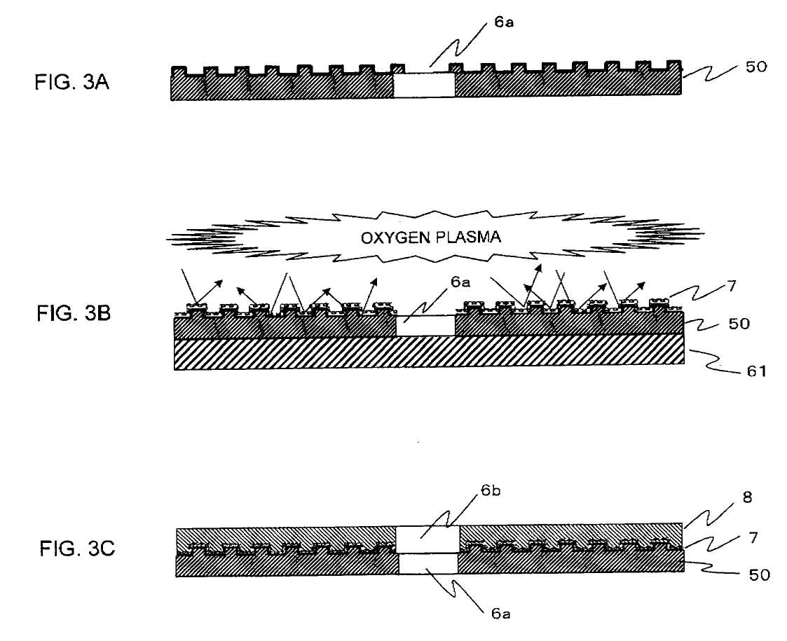

FIG. 2C shows the father stamper 50 just after the detaching. The father stamper 50 has its flat back-surface polished, if necessary, and is subjected to oxygen-RIE (Reactive Ion Etching) not shown in the figure in order to remove resist residues by ashing. The ashing allows it to clean the concavo-convex surface of the father stamper 50 to provide the final father stamper 50, shown in FIG. 3A, the father stamper 50 having an inverted concavo-convex pattern in comparison with the original disk. FIGS. 3A to 3C show a process to form a mold release film on the father stamper 50 and to subsequently form a new electroformed film 8 thereon.

The father stamper 50 is placed on a disk holder 61 of a plasma-oxidation apparatus with the flat back-surface thereof face-down in order to oxygenate the concavo-convex surface thereof, as shown in FIG. 3B. Then, a thin oxide film is uniformly formed using oxygen plasma as a first mold release film 7 on the concavo-convex surface of the father stamper 50 of Ni or Ni alloy. The first mold release film 7 is formed with a thickness of about 5 nm. Since the first mold release film 7 is very thin, a tunnel current can flow therethrough, although the film 7 is made of insulating oxide. Thus, the first mold release film 7 has electrical conductivity necessary for electroforming.

Consequently, a second electroformed film 8 (a second metal film) is electroformed directly on the father stamper covered with the first mold release film 7. Alternatively, a thin conducting film (not shown in the figure) may be further formed on the first mold release film 7 in order to enhance the electrical conductivity. This very thin first mold release film 7 has two functions. One is to ensure the electrical conductivity necessary for electroforming thereon, although the film 7 is made of oxide. The other is to allow it to easily detach a mother stamper described later from the father stamper 50.

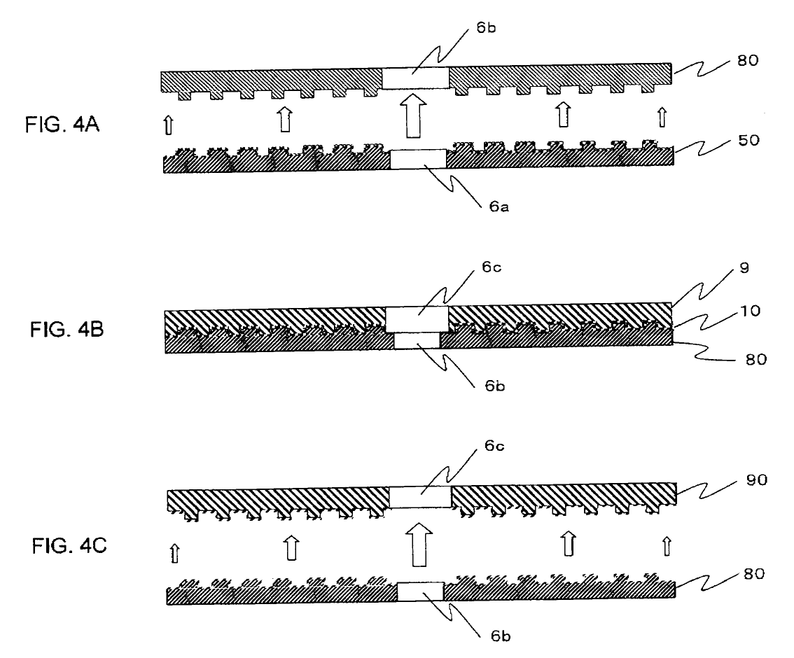

A second electroformed film 8 to be a mother stamper 80 is formed on the first mold release film 7 of the father stamper 50, as shown in FIG. 3C. The father stamper 50 has the first apertural area 6a in the central portion 6 thereof, and the laminated film of the first electroformed film 5/the first conducting film 4 is not formed basically on the area 6a. Therefore, the second electroformed film 8 is not formed on the central portion 6, but formed entirely on the father stamper 50 except for the central portion 6 thereof. That is, the second electroformed film 8 is provided with a second apertural area 6b, and is formed entirely on the father stamper 50 except for the central portion thereof. The second electroformed film 8 succeeds an inverted concavo-convex pattern in comparison with the father stamper 50. FIGS. 4A to 4C show a step to detach the electroformed film 8 from the father stamper 50, a step to subsequently form a new electroformed film 9 on a mother stamper 80, and a step to detach the electroformed film 9 form the mother stamper 80 for providing a son stamper 90.

Then, as shown in FIG. 4A, the second electroformed film 8 is detached from the father stamper 50 to provide the mother stamper 80 with an inverted concavo-convex pattern in comparison with the father stamper 50. The detaching is carried out in a similar way to the case where the laminated film of the first electroformed film 5 and the first conducting film 4 is detached from the original disk 1, as shown in FIGS. 2A to 2C. That is, the innermost circular edge of the second electroformed film 8 at the second apertural area 6b is pulled toward the upper direction to initiate the detaching from the innermost circular edge, the detaching developing concentrically as shown in FIG. 2A. Thus, the innermost circular edge of the second apertural area 6b, which is detached initially, is pulled and lifted uniformly over the whole circumference toward the upper direction. Alternatively, a gas may be blown into the apertural area with lifting up the innermost circular edge of the electroformed films.

Then, the mother stamper 80 has its flat back-surface polished, if necessary, in a similar way to the manufacturing process of the father stamper 50. The mother stamper 80 is placed with the flat back-surface thereof face-down on a disk holder (not shown in the figure) of an RIE apparatus, and is subjected to oxygen-RIE not shown in the figure in order to remove resist residue adhered to the mother stamper 80 by ashing. Thus, the concavo-convex surface of the mother stamper 80 is cleaned. Then, the mother stamper is further subjected to oxygen-plasma treatment to form an oxide film thereon as a second mold release film 10.

A third electroformed film 9 (a third metal film) is formed on the second mold release film 10 of the mother stamper 50, as shown in FIG. 3C. The third electroformed film 9 is deposited on the remainder area except for the central portion 6b of the mother stamper 80, because the second electroformed film has not been deposited on the central portion of the mother stamper 80. That is, the third electroformed film 9 is provided with a third apertural area 6c, and is formed entirely on the mother stamper 80 except for the central portion thereof. The third electroformed film 9 succeeds an inverted concavo-convex pattern in comparison with the mother stamper 80.

Then, as shown in FIG. 4C, the third electroformed film 9 is detached from the mother stamper 80 to provide the son stamper 90 with a concavo-convex pattern inverted in comparison with that of the mother stamper 80. The detaching of the third electroformed film 9 is carried out in a similar way to the cases where the laminated film of the first electroformed film 5/the first conducting film 4 is detached from the original disk 1, and where the second electroformed film 8 is detached from the father stamper, as shown in FIGS. 2A to 2C. That is, the innermost circular edge of the third electroformed film 9 at the third apertural portion 6c is pulled toward the upper direction to initiate the detaching from the edge concentrically as shown in FIG. 2A. Thus, the innermost circular edge at the third apertural area 6c, which is detached initially, is pulled and lifted uniformly over the whole circumference toward the upper direction. Then, the son stamper 90 is finally fixed to the metallic mold of a plastic injection molding machine to mass-produce media with the same track pattern as that of the original disk on the basis of transfer printing of the pattern.

As explained above, according to the first embodiment, the father stamper 50, the mother stamper 80 and the son stamper 90 can be detached from their innermost circular edges of their central apertural areas to their outermost circular edges concentrically and uniformly. This allows it to be extremely improbable that the concavo-convex patterns of the stampers deform at the time of the detaching. Even if deformations take place, the amount of the deformations is negligible small. According to the embodiment, DTR media manufactured using the father stamper or son stamper give rise to almost no RRO problem. Accordingly, stable high-density-recording/reproduction is realizable.

The innermost circular edge around at the central portion of an electroformed film is initially detached to provide the stamper, allowing it to reduce the incidence and interfusion of the dusts, compared with the conventional methods. This creates no risk of spoiling the flatness of the track of the DTR media.

### Second Embodiment

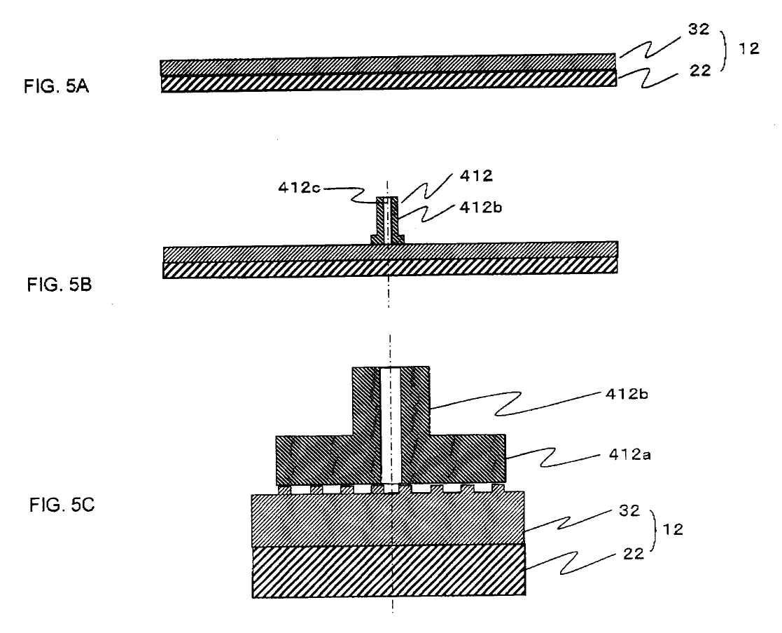

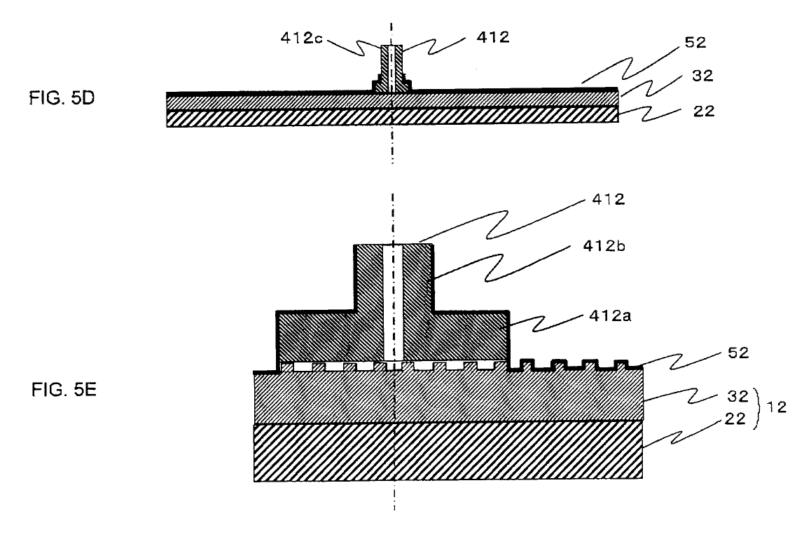

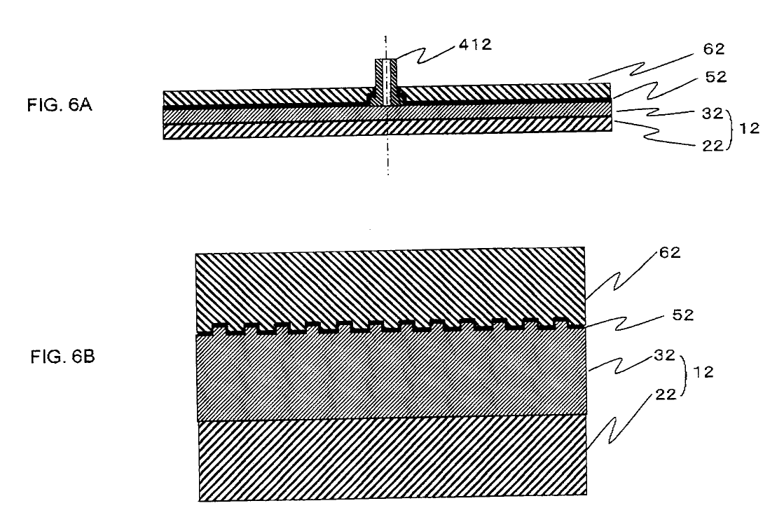

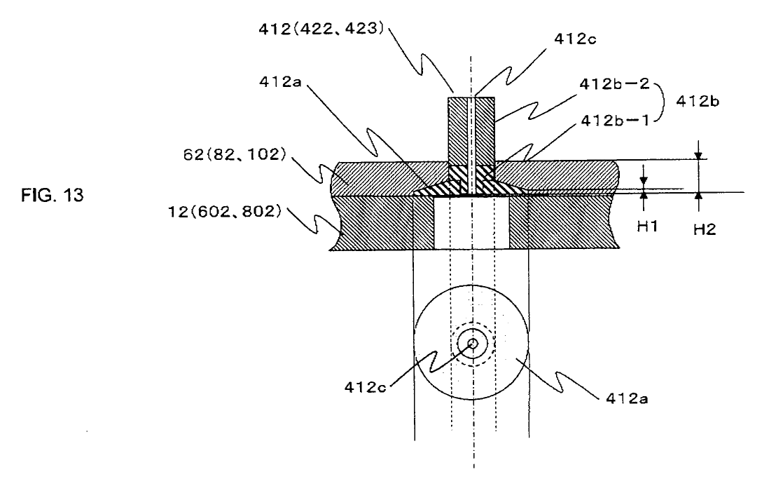

A manufacturing method of a duplicating stamper according to a second embodiment is explained with reference to FIGS. 5A to 13. FIGS. 5A to 12 are schematic sectional-views of the duplicating stamper at respective manufacturing steps according to the second embodiment. FIG. 13 is a schematic view showing a pin to be used in the manufacturing process according to the second embodiment.

FIGS. 5A to 5E show a process to form a first conducting film 52 for electroforming on an original disk 12 with a pin 412 placed thereon. As shown in FIG. 5A, the original disk 12 is provided with a resist film 32 on a glass substrate 22, the resist film having a concavo-convex pattern formed concentrically of the DTR medium for a hard disk. The concavo-convex pattern is omitted in FIGS. 5A and 5B.

A first pin 412 is placed an the central portion of the original disk 12, as shown in FIG. 5B. The first pin 412 includes a bottom 412a and a column 412b of which central axis is in conformity with the central axis of the bottom 412a. The bottom surface of the bottom 412a is fixed to be in contact with the surface of the resist film 32. The column 412b is provided with an air duct 412c formed along the central axis thereof. Alternatively, the air duct 412c may be screened for using. Here, although the resist film 32 has convexoconcave on the surface thereof as shown in FIG. 5C, the scale of the convexoconcave is several orders of magnitude smaller than that of the bottom 412a of the pin 412. Therefore, the first pin 412 can be placed on the resist film 32 without any problem as if the pin 412 is placed on the “flat” surface of the resist film 32 as shown in FIG. 5B. The pin will be explained more in detail later in FIG. 13.

The first conducting film 52 is formed by sputtering on the surface of the resist film 32 of the original disk 12 with the pin 412 as shown in FIG. 5D. The first conducting film 52 is deposited on the sidewall and upper surface of the bottom 412a of the first pin 412 and on the side wall of the Column 412b near the bottom 412a as shown in FIG. 5E, an enlarged view of FIG. 5D. However, the first conducting film 52 is not deposited on the resist film 32 on the central area of the original disk 12, because the first pin 412 covers the central area of the disk 12 so as to block off the deposition of the first conducting film onto the central area thereof.

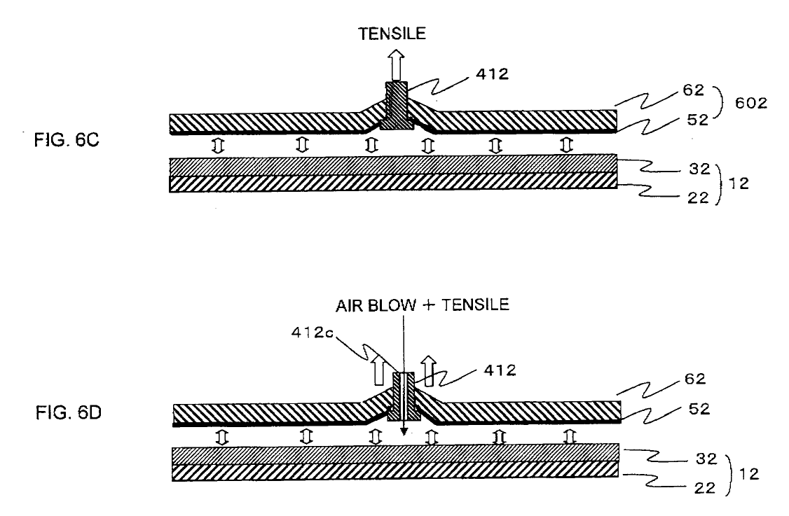

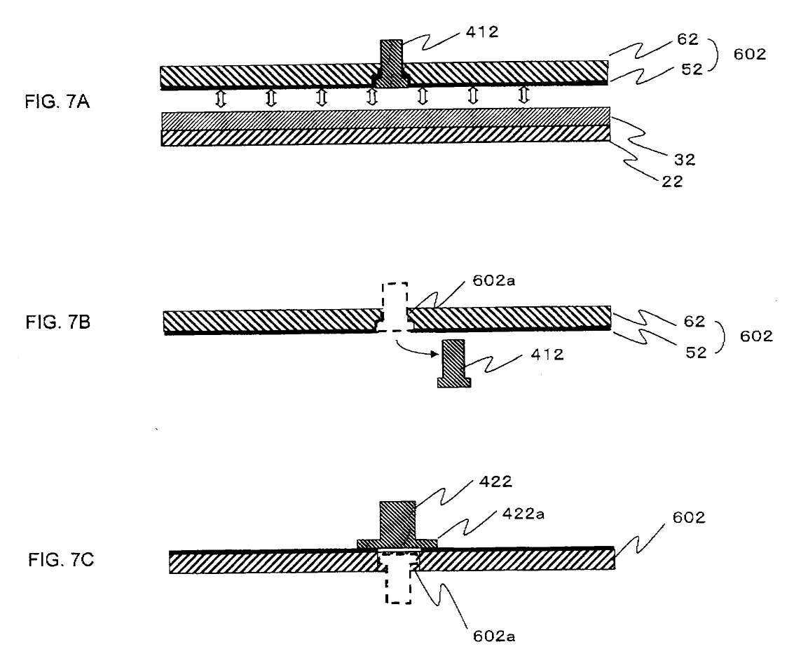

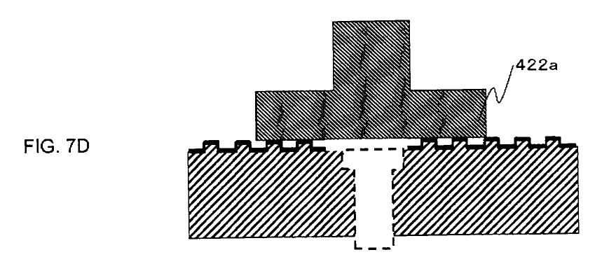

FIGS. 6A to 6D show a process to form a first electroformed film 62 on the original disk 12 with the pin 412 placed thereon and to subsequently detach the film 62 by lifting the innermost circular edge initially. The original disk 12 with the first pin 412 fixed thereon is immersed in an electrolysis solution to electroform the first electroformed film 62 (a first metal film) on the first conducting film 52 of the original disk 12 as shown in FIG. 6A. The first electroformed film 62 is formed so that the convexoconcave of the resist film 32 is filled in therewith to disappear on the surface of the first electroformed film 62, as shown in FIG. 6B, i.e., the enlarged view of FIG. 6A. The first electroformed film 62 is formed also on the upper surface of the bottom 412a of the first pin 412 and the sidewall of the column 412b thereof near the bottom 412a. FIGS. 7A to 7D show a process to unfix the pin 412 from a father stamper 602 and to subsequently place a new pin 422 on a concavo-convex pattern of the father stamper 602.

As shown in FIG. 6C, the first pin 412 is lifted up to detach a laminated film of the first electroformed film 62 and the first conducting film 52 from the resist film 32. Thus, the father stamper 602 is provided as shown in FIG. 7A. The detaching is initiated from the innermost circular edge of the central apertural area of the laminated film including the first electroformed film 62 and the first conducting film 52, and develops to their outermost circular edge concentrically and uniformly. Therefore, there is no risk of deforming the concavo-convex pattern of the father stamper 602.

Alternatively, the detaching of the laminated film of the first electroformed film 62 and the first conducting film 52 may be carried out with instilling air into the air duct 412c to assist the detaching, as shown in FIG. 6D.

In FIGS. 6C and 6D, the central area detached initially of the laminated film of the first electroformed film 62/the first conducting film 52 is drawn as if deformed greatly. In fact, the deformation of the first electroformed film 62/the first conducting film 52 takes place within a range of the elastic deformations thereof. Therefore, no plastic deformation accompanied by the detaching remains in the central area of the laminated film of the first electroformed film 62/the first conducting film 52 to be a father stamper 602. This allows it to form the father stamper 602 without deformations not only around in the central area but also as a whole.

Next, the first pin is unfixed from the father stamper 602, as shown in FIG. 7B. The father stamper 602 is subjected to oxygen-RIE, etc. in order to remove resist residues adhering to the concavo-convex surface thereof by ashing and to clean the concavo-convex surface thereof.

A second pin 422 is subsequently placed on the father stamper so as to screen the first apertural area 602a in the central area of the father stamper 602 as shown in FIG. 7C. The second pin 422 is configured in the same way as the first pin 412, but the diameter of the disk-like bottom 422a of the former is larger than that of the latter. Here, in FIG. 7D, the bottom surface of the bottom 422a of the second pin 422 is shown exaggeratingly to be in touch with the concavo-convex surface of the father stamper 602. In fact, the scale of the concavo-convex surface is several orders of magnitude smaller than that of the bottom 422a of the pin 422. Therefore, the second pin 422 can be placed as is placed on a flat surface.

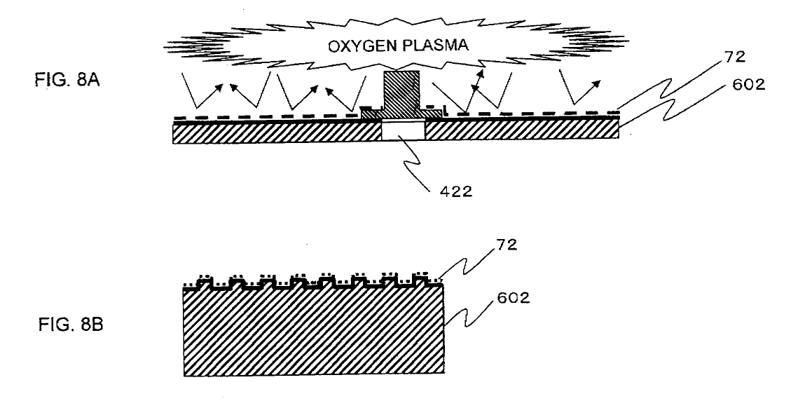

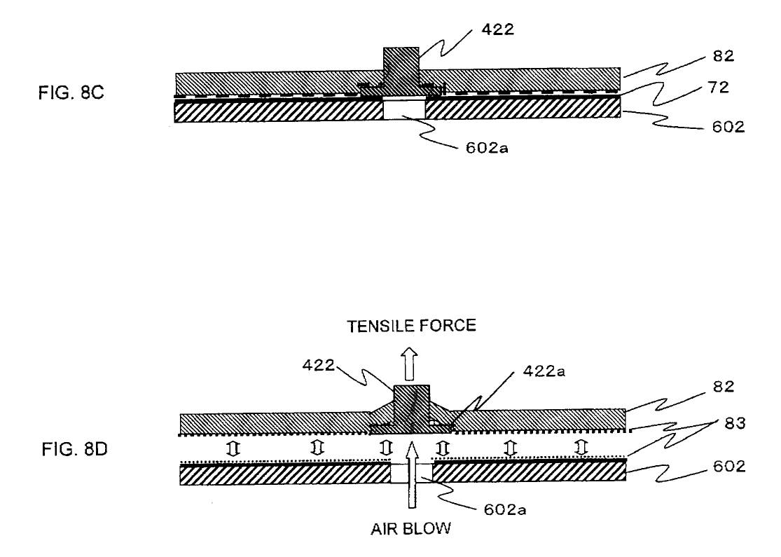

Then, a thin oxide film is uniformly formed as a first mold release film 72 on the concavo-convex surface of the father stamper 602 using oxygen plasma, as shown in FIG. 8A. The concavo-convex surface of the father stamper 602 is coated with a first mold release film 72 precisely, as shown in FIG. 8B. FIGS. 8A to 8D show a process to form the mold release film 72 on the father stamper 602 with the pin 422 placed thereon and to subsequently form a new electroformed film 82 thereon, of which innermost circular edge is lifted for detaching.

As shown in FIG. 8C, the father stamper 602 with the second pin 422 fixed thereon is immersed in an electrolysis solution not shown in the figure to electroform a second electroformed film 82 (a second metal film) on the first mold release film 72 thereof. The second electroformed film 82 is formed such that the convexoconcave of the father stamper 602 is filled in therewith.

As shown in FIG. 8D, the second electroformed film 82 is detached to manufacture a mother stamper 802. The second pin 422 is lifted up to detach the second electroformed film 82 in a way similar to the case of the father stamper 602. That is, the detaching of the innermost circular edge at the second apertural portions of the second electroformed film 82 is initiated by the second pin 422 over the whole circumference of the circular edge simultaneously, and develops from the innermost circular edge toward the outermost circular edge circumferentially and uniformly. This creates no risk of deforming the concavo-convex pattern of the second electroformed film 82. Alternatively, the detaching of the second electroformed film is assisted by blowing air into the apertural area 602a to make the detaching easier, as shown in FIG. 8D. The shape of the convexoconcave is omitted in FIGS. 8C and 8D.

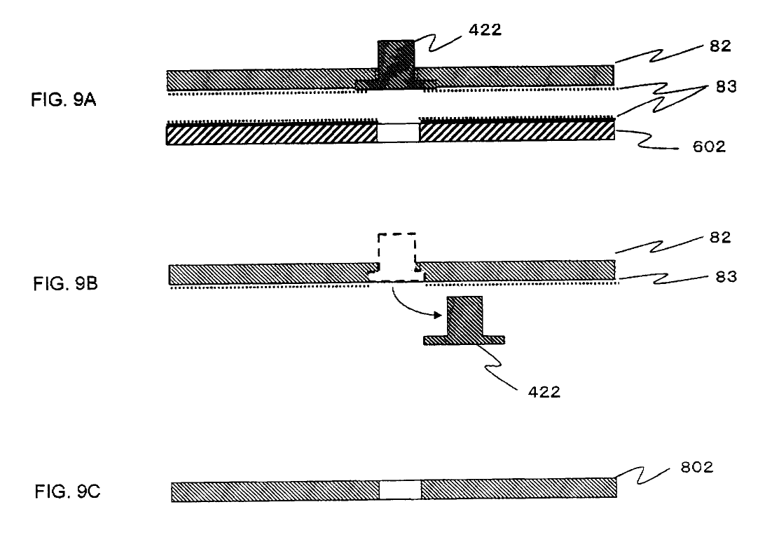

In FIG. 8D, the central area of the second electroformed film 82 is drawn with exaggeration as if deformed greatly during the detaching. In fact, the deformation of the second electroformed film 82 takes place within a range of the elastic deformations thereof. Therefore, no plastic deformation accompanied by the detaching remains at the central area of the second electroformed film 82 as shown in FIG. 9A. FIGS. 9A to 9C show a process to unfix the pin 422 from the second electroformed film 82 to provide the mother stamper 802.

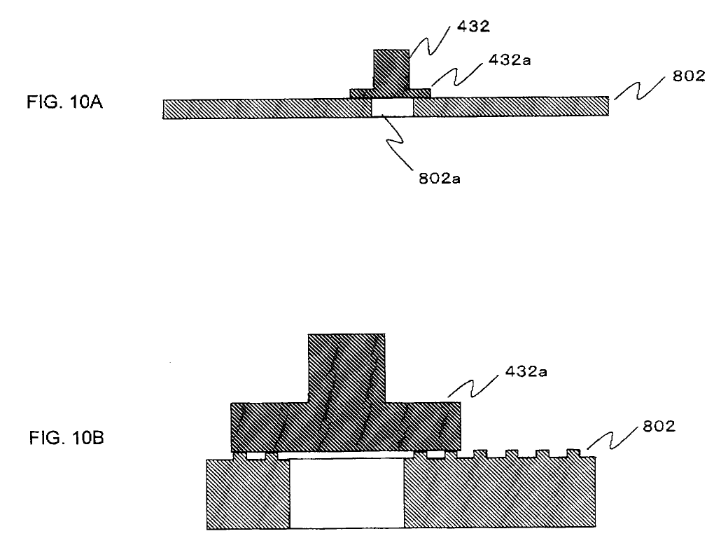

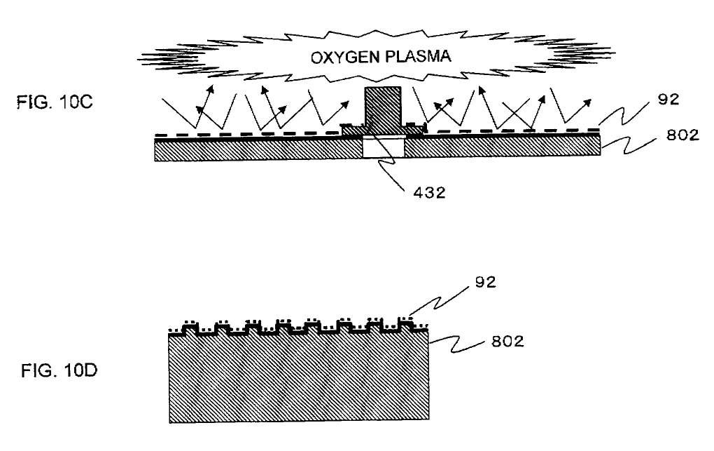

Next, the second pin 422 is unfixed from the second electroformed film 82, as shown in FIG. 9B. Furthermore, residues 83, etc remaining on the second electroformed film 82 is removed by cleaning to provide the mother stamper 802 inherited an inverted concavo-convex pattern from the father stamper 602. FIGS. 10A to 10D show a process to form a second mold release film 92 on the mother stamper 802 with the pin 432 thereon.

After cleaning the mother stamper 802, a third pin 432 is subsequently placed on the mother stamper 802 to screen a second apertural area 802a in the central area thereof as shown in FIG. 10A. Here, in FIG. 10B, the bottom surface of the bottom 432a of the third pin 432 is shown exaggeratingly to be in touch with the concavo-convex surface of the mother stamper 802. In fact, the scale of the concavo-convex surface is several orders of magnitude smaller than that of the bottom 432a of the pin 432. Therefore, the third pin 432 can be placed as is placed on a flat surface.

A Ni-oxide film is formed as the second mold release film 92 on the mother stamper 802 with the third pin 432 placed thereon, as shown FIG. 10C. The Ni-oxide film is provided by oxygenating the surface of the second electroformed film 82 for the Ni-based mother stamper 802 using oxygen plasma. The Ni-oxide film is formed with a thickness of about 5 nm. The concavo-convex surface of the mother stamper 802 is coated with the second mold release film 92 precisely, as shown in FIG. 10D. The second mold release film 92 allows it to ease the later detaching of a third electroformed film 1102 and the transfer printing of the concavoconvex pattern.

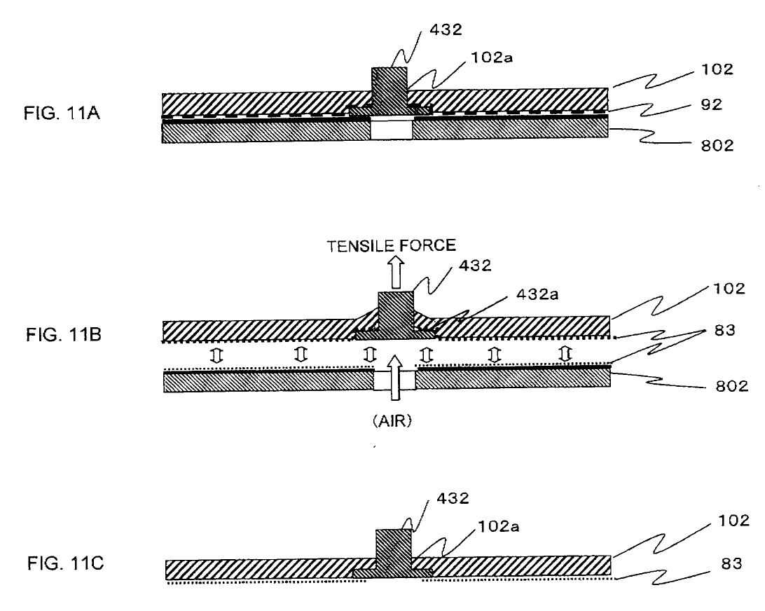

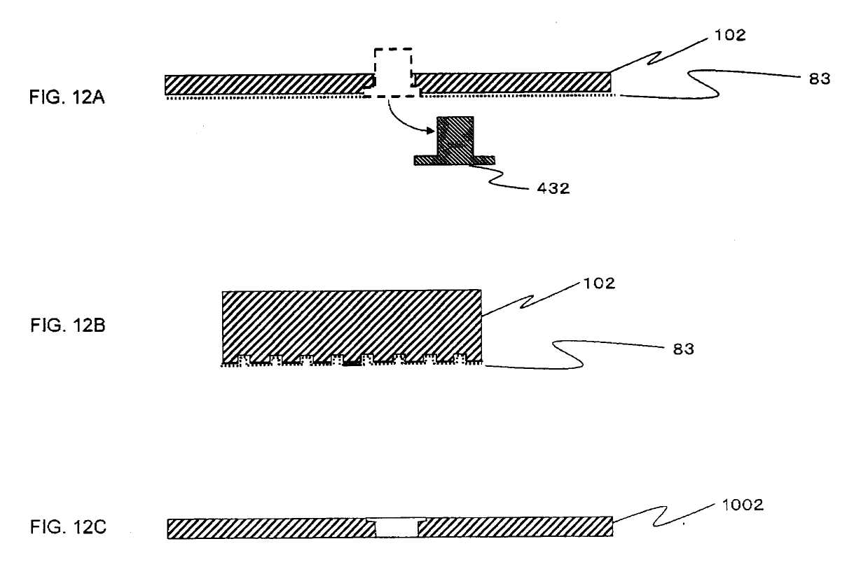

Then, as shown in FIG. 11A, a third electroformed film 102 (a third metal film) is formed on the mother stamper 802 and the second mold release film 92 on the bottom 432a of the third pin 432. Subsequently, the mother stamper 802 with the third pin 432 placed thereon is immersed in a bath of nickel-sulfamate to electroform the third electroformed layer 102. A third apertural area 102a is formed in the central area of the third electroformed layer 102. FIGS. 11A to 11C show a process to form the third electroformed film 102 and to subsequently detach the film 102.

Then, the third electroformed film 102 is detached from the mother stamper 802 to acquire a son stamper 1002, as shown in FIG. 11B. The third pin 432 is lifted up to detach the second electroformed film 82 in a similar way to the cases of the father stamper 602 and the mother stamper 802. That is, the detaching of the innermost circular edge in the third apertural area 102a of the third electroformed film 102 is initiated by the third pin 432 over the whole circumference of the innermost circular edge simultaneously, and develops from the innermost circular edge toward the outermost circular edge circumferentially and uniformly. This creates no risk of deforming the concavo-convex pattern of the third electroformed film 102. Alternatively, the detaching of the third electroformed film 102 is assisted by blowing air into the apertural area 602a at the time of lifting the third pin 432 to make the detaching easier, as shown in FIG. 11B.

In FIG. 11B, the central area of the third electroformed film 102 is drawn with exaggeration as if deformed greatly during the detaching. In fact, the deformation of the third electroformed film 102 takes place within a range of the elastic deformations thereof. Therefore, no plastic deformation accompanied by the detaching remains in the central area of the third electroformed film 102.

Next, as shown in FIG. 12A, the third pin 432 is unfixed from the third electroformed film 102. Furthermore, the residues 83, etc remaining on the third electroformed film 102 is removed by cleaning to provide a son stamper 1002, as shown in FIG. 12C. FIG. 12B is a sectional view schematically showing the concavo-convex pattern of the son stamper 1002 inherited from the mother stamper 802. FIGS. 12A to 12C show a process to unfix the pin 432 and to clean the third electroformed film 102 for the son stamper 1002.

FIG. 13 is a sectional view minutely showing the first, second and third pins 412, 422 and 432 used in the manufacturing process according to the second embodiment. The first, second and third pins 412, 422 and 432 are placed on the central areas of the original disk 12, the father stamper 602 and the mother stamper 802, respectively, so that the first electroformed film 62, the second electroformed film 82 and the third electroformed film 102 are not formed on the central areas thereof. The first, second and third pins 412, 422 and 432 include disk-like bottoms 412a, 422a and 432a, and columns 412b, 422b and 432b provided along the central axis of these bottoms 412a, 422a and 432a. The diameters of the bottoms 412a, 422a and 432a are larger than those of the columns 412b, 422b and 432b.

The bottoms 412a, 422a and 432a are made of a metallic material. The columns 412b, 422b and 432b include the metallic columns 412b-1, 422b-1 and 432b-1, and the electrically-insulating columns 412b-2, 422b-2 and 432b-2.

The pins 412, 422 and 432 are provided with the air ducts 412c, 422c and 432c. The air ducts 412c, 422c and 432c are provided so as to pass through from the columns 412b, 422b and 432b to the bottoms 412a, 422a and 432a. Alternatively, the air ducts may be screened to use.

The bottoms 412a, 422a and 432a of the pins 412, 422 and 432 have a surface sloping toward the bottom surfaces thereof, and a thin outer-circumferential edge like a knife-edge. In the second embodiment, the thickness H1 of the outer-circumferential edge of the bottoms 412a, 422a and 432a is about a third or less of the thickness H2 of the electroformed films 62, 82, and 102. This creates no risk of breaking the electroformed films in the central edges thereof at the time of detaching. Therefore, this allows it to efficiently suppress the incidence of dusts accompanied by detaching.

The heights of the metallic column portions 412b-1, 422b-1 and 432b-1 of the pins 412, 422 and 432 are set to the thickness H2 approximately. This allows it to suppress unnecessary deposition of the electroformed films on the insulating column portions 412b-2, 422b-2 and 432b-2, and the incidence of dusts.

In the second embodiment, for manufacturing the father stamper 602, the first pin 412 is placed on the central portion of the original disk 12. Then, the first electroformed film 62 is formed over the original disk 12 and the bottom 412a of the first pin 412 to acquire the father stamper 602. Furthermore, for manufacturing the mother stamper 802, the second pin 422 is placed on the central portion of the father stamper 602. Then, the second electroformed film 82 is formed over the father stamper 602 and the bottom 422a of the second pin 422 to acquire the mother stamper 802. For manufacturing the son stamper 1002, the third pin 432 is placed on the central portion of the mother stamper 802. Then, the third electroformed film 102 is formed over the mother stamper 802 and the bottom 432a of the third pin 432 to acquire the son stamper 1002. Then, the first pin 412, the second pin 422 and the third pin 432 are lifted up to detach the father stamper 602, the mother stamper 802 and the son stamper 1002 from the original disk 12, the father stamper 602 and the mother stamper 802, respectively. The detaching of each stamper is initiated from the innermost circular edges of the first, second and third apertural areas 602a, 802a and 102a toward the outermost edges thereof circumferentially and uniformly, thus eliminating the risk of deforming the concavo-convex patterns of the respective stampers. The pins allow it to precisely form the initial detaching edges and suppress the dusts to low levels. According to the manufacturing method of the stampers of the invention, it is possible to manufacture a stamper without deformation of the concavo-convex pattern thereof and the incidence of the dusts accompanied by detaching.

In the above-mentioned embodiment, a Ni-based material, i.e., a Ni alloy is employed for the conducting films or the electroformed film. The electroformed films may include cobalt, sulfur or phosphorus.

The embodiments of the present invention have been described above. The present invention is not limited to the embodiments. For example, when those skilled in the art appropriately select to combine two or more of the examples as described above with reference to the figures from a known range, and the same effect as described above can be obtained, they are also incorporated in the present invention. Various changes and modifications can be made without departing from the spirit and scope of the present invention, being also incorporated in the present invention.

What is claimed is:

1. A method for manufacturing a duplicating stamper, comprising the steps of:
forming a metal film on a stamper, the metal film having an apertural area in a central area of the stamper;
lifting up an innermost circular edge of the metal film in order to detach the metal film from the innermost circular edge to an outermost circular edge of the metal film; and
detaching the metal film from the stamper to provide another stamper.

2. The method according to claim 1, wherein a gas is blown into the apertural area with lifting up the innermost circular edge of the metal film.

3. The method according to claim 1, wherein the metal film is an electroformed film.

4. The method according to claim 2, wherein the metal film is an electroformed film.

5. The method according to claim 3, wherein the apertural area is circular in shape.

6. The method according to claim 4, wherein the apertural area is circular in shape.

7. A method for manufacturing a duplicating stamper, comprising the steps of:
placing a first pin on a surface of a central area of a original disk, the first pin having a column and a bottom of which diameter is larger than that of the column, so that the bottom of the first pin is in contact with the surface of the central area of the original disk;
forming a first metal film on the surface of the original disk and on the bottom of the first pin;
detaching the first metal film from the original disk to provide a father stamper with a first apertural area in a central portion of the father stamper;
placing a second pin with a column and a bottom of which diameter is larger than that of the column so as to screen the first apertural area of the father stamper to form a second metal film on a surface of the father stamper and on the bottom of the second pin;
detaching the second metal film from the father stamper to provide a mother stamper with a second apertural area in a central portion of the mother stamper;
placing a third pin with a column and a bottom of which diameter is larger than that of the column so as to screen the second apertural area of the mother stamper to form a third metal film on a surface of the mother stamper and on the bottom of the third pin; and
detaching the third metal film from the mother stamper to provide a son stamper,
wherein
the first pin, the second pin and the third pin have an air duct provided along a central axis of the columns of the first pin, the second pin and the third pin, the air duct passing through the columns and the bottoms of the first pin, the second pin and the third pin;
wherein
a gas is instilled into the apertural areas through the air ducts of the first pin, the second pin and the third pin with lifting up the innermost circular edges of the first metal film, the second metal film and the third metal film to assist in detaching the first metal film, the second metal film and the third metal film.

8. The method according to claim 7, wherein the first metal film, the second metal film and the third metal film are electroformed.

9. The method according to claim 7, wherein the first apertural area, the second apertural area and the third apertural area are circular in shape.
